(19) United States
(12) Patent Application Publication
(10) Pub. No.: US 2013/0284000 A1
(43) Pub. Date: Oct. 31, 2013

(54) MUSIC NOTE POSITION DETECTION APPARATUS, ELECTRONIC MUSICAL INSTRUMENT, MUSIC NOTE POSITION DETECTION METHOD AND STORAGE MEDIUM

(71) Applicant: CASIO COMPUTER CO., LTD., Tokyo (JP)

(72) Inventor: Hiroyuki SASAKI, Tokyo (JP)

(73) Assignee: Casio Computer Co., Ltd., Tokyo (JP)

(21) Appl. No.: 13/868,029

(22) Filed: Apr. 22, 2013

(30) Foreign Application Priority Data
Apr. 25, 2012 (JP) 2012-099643

(51) Int. Cl. G10H 1/00

(52) U.S. Cl. CPC G10H 1/0008
USPC 84/609

(57) ABSTRACT

In the present invention, a CPU detects bar lines in a musical score image to divide at each bar line, and obtains the layout range of music notes in each measure obtained by the division. Subsequently, the CPU estimates the position of each music note in the obtained layout range by using music note data, and detects a matching value and a detected position of a music note at the estimated position as position candidates. Then, the CPU excludes a musically improper position candidate from among the detected position candidates, and determines the detected position of a position candidate having the highest matching coefficient among the remaining position candidates as the position of the music note.

### CROSS-REFERENCE TO RELATED APPLICATION

This application is based upon and claims the benefit of priority from the prior Japanese Patent Application No. 2012-4099643, filed Apr. 25, 2012, the entire contents of which is incorporated herein by reference.

### BACKGROUND OF THE INVENTION

1. Field of the Invention

The present invention relates to a music note position detection apparatus, an electronic musical instrument a music note position detection method, and a storage medium by which, based on a musical score image and music note data that are of the same musical piece but are independent from and not correlated with each other, the position of a music note in the musical score image corresponding to a sound represented by the music note data is detected.

2. Description of the Related Art

Users who desire to enjoy music, in particular, beginners, often do not know which sound is produced for a music note displayed on a musical score. For this reason, in recent years, various technologies have been developed which enable intuitive recognition of a correspondence between a music note displayed on a musical score and music note data representing the music note. For example, Japanese Patent No 3980888 discloses a technology in which music note data stored in a storage section is displayed on a screen as a musical score and, when a touch operation is performed on a desired music note in the musical more by using a touch panel provided on the display screen, a musical sound of the music note at the touched point is emitted.

In the technology disclosed in Japanese Patent No. 3980888, a plurality of music note data representing respective sounds constituting a musical piece and display positions of the respective music notes displayed on the musical score are associated in advance with each other. As a result, the sound of a music note specified by a touch operation can be emitted. However, there is a problem in that the position of a music note in a musical score image corresponding to a sound represented by music note data cannot be detected based on the musical score image and the music note data that are of the same musical piece but are independent from and not correlated with each other.

### SUMMARY OF THE INVENTION

The present invention has been conceived in light of the above-described problems. An object of the present invention is to provide a music note position detection apparatus, a music note position estimation method, and program by which, based on a musical score image and music note data that are of the same musical piece but are independent from and not correlated with each other, the position of a music note in the musical score image corresponding to a sound represented by the music note data can be detected.

In accordance with one aspect of the present invention, there is provided a music note position detection apparatus comprising: an obtaining section which detects bar lines in musical score image data to divide at each bar line, and obtains a layout range of music notes in each measure obtained by division; an extracting section which estimates a position of each music note in the layout range obtained by the obtaining section by using a plurality of music note data constituting a musical piece, and extracts a matching value between the music note at the estimated position and a position of the music note detected on the musical score image data, and the detected position of the music note, as position candidates; and a determining section which excludes a musically improper position candidate from among the position candidates extracted by the extracting section, and determines a detected position of a remaining position candidate as a position of the music note.

In accordance with another aspect of the present invention, there is provided a non-transitory computer-readable storage medium having stored thereon a program that is executable by a computer, the program being executable by the computer to perform functions comprising: obtainment processing for detecting bar lines in musical score image data to divide at each bar line, and obtaining a layout range of music notes in each measure obtained by division; extraction processing for estimating a position of each music note in the layout range obtained in the obtainment processing by using a plurality of music note data constituting a musical piece, and extracting a matching value between the music note at the estimated position and a position of the music note detected on the musical score image data, and the detected position of the music note, as position candidates; determination processing for excluding a musically improper position candidate from among the position candidates extracted in the extraction processing, and determining a detected position of a remaining position candidate as a position of the music note.

In accordance with another aspect of the present invention, there is provided a music note position detection method comprising: detecting bar lines in musical score image data to divide at each bar line, and obtaining a layout range of music notes in each measure obtained. by division; estimating a position of each music note in the obtained layout range by using a plurality of music note data constituting a musical piece, and extracting a matching value between the music note at the estimated position and a position of the music note detected on the musical score image data, and the detected position of the music note, as position candidates; and excluding a musically improper position candidate from among the extracted position candidates, and determining a detected position of a remaining position candidate as a position of the music note.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram showing the structure of a first embodiment;

FIG. 2 is a flowchart of the operation of music note position detection processing;

FIG. 3 is a flowchart of the operation of the music note position detection processing;

FIG. 4 is a diagram showing an example of a preliminary detection range;

FIG. 5 is a diagram showing an example of a music note position curve;

FIG. 6 is a diagram showing an example of a matching range;

FIG. 7 is a flowchart of the operation of musical grammar filter processing;

FIG. 8 is a diagram showing an example of adjacent music notes;

FIG. 9 is a flowchart of the operation of musical performance processing according to a second embodiment;

FIG. 10 is a diagram showing an example of oval detection;

FIG. 11 is a diagram showing an example of sound emission time search;

FIG. 12 is a flowchart of the operation of musical performance processing by a modification example of the second embodiment;

FIG. 13 is a diagram showing a correspondence between an operation position and a music note for which a sound is emitted;

FIG. 14 is a diagram showing an example of a music note and a keyboard display in a musical score; and

FIG. 15 is a diagram showing an example of operation of a pass over a bar line.

### DETAILED DESCRIPTION OF THE PREFERRED EMBODIMENTS

Embodiments of the present invention are described below with reference to the drawings.

### First Embodiment

A. Structure

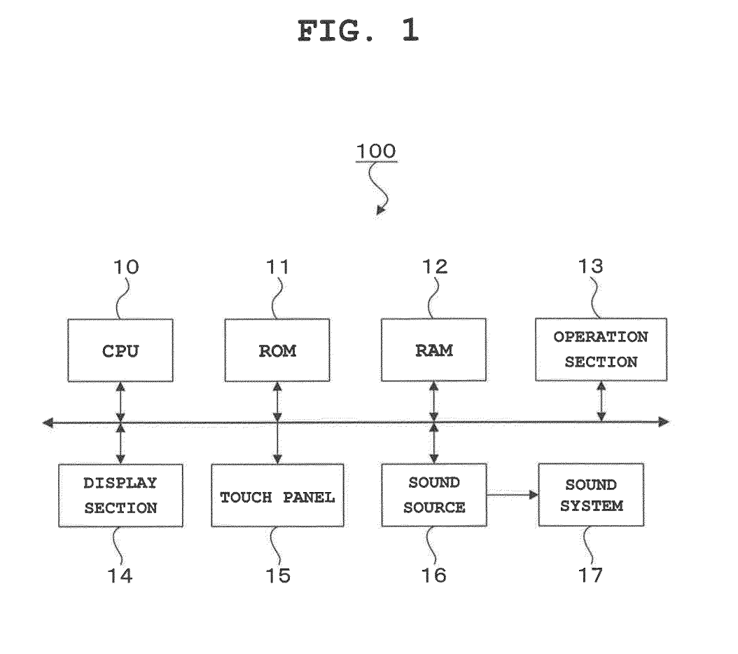

FIG. 1 is a block diagram showing the structure of an electronic musical instrument 100 including a music note position detection apparatus according to a first embodiment of the present invention. A CPU (Central Processing Unit) 10 in FIG. 1 controls each section of the musical instrument according to an operation event generated by an operation section 13 and a touch operation signal generated by a touch panel 15. The CPU 10 has a function according to the feature of the present invention in which, based on a musical score image and music note data that are of the same musical piece but are independent from and not correlated with each other, the position of a music note in the musical score image corresponding to a sound represented by the music note data is detected. This function will be described further below.

A ROM (Read-Only Memory) 11 has stored therein various control programs to be loaded into the CPU 10. These various control programs include a program for music note position detection processing, which will be described further below. A RAM (Random Access Memory) 12 includes a work area, a data area, and a music note position storage area. In the work area of the RAM 12, various registers and flag data that are used in processing by the CPU 10.

In the data area of the RAM 12, musical score image data (in a bit map format) to be displayed on the screen of a display section 14 and a plurality of music note data representing respective sounds constituting a musical piece. The musical score image data and the music note data herein are of the same musical piece, but are independent from and not correlated with each other. The music note data is represented in a known MIDI data format. In the music note position storage area of the RAM 12, the positions of respective music notes in a musical score obtained from music note position detection processing described further below are stored.

The operation section 13 has various operation switches arranged on an apparatus panel, and generates a switch event corresponding to the type of a switch operated by a user. The switch event generated by the operation section 13 is loaded into the CPU 10. The operation section 13 is provided with a power switch for power-on/off and, for example, a mode switch for specifying a mode for performing the music note position detection processing, which will he described further below, and a timbre selection switch for selecting a timbre of a musical sound to be emitted.

The display section 14 includes a color liquid-crystal panel and the like and, in response to a display control signal supplied from the CPU 10, performs screen display of a musical score image based on musical score image data stored in the data area of the RAM 12 and screen display of states, such as a setting state and an operation state, of the musical instrument. The touch panel 15 includes a multi-touch-type touch screen arranged on the display screen of the display section 14, and outputs an operation signal according to a touch operation performed on the touch screen. The outputted operation signal is loaded into the CPU 10. A sound source 16 is configured by a known wave memory read scheme, and generates musical sound data according to an event supplied from the CPU 10. A sound system 17 converts the musical sound data outputted from the sound source 16 to a musical sound signal in an analog format, and after amplifying the musical sound signal, emits the sound from a loudspeaker.

B. Operation

(1) Operation of Music Note Position Detection Processing

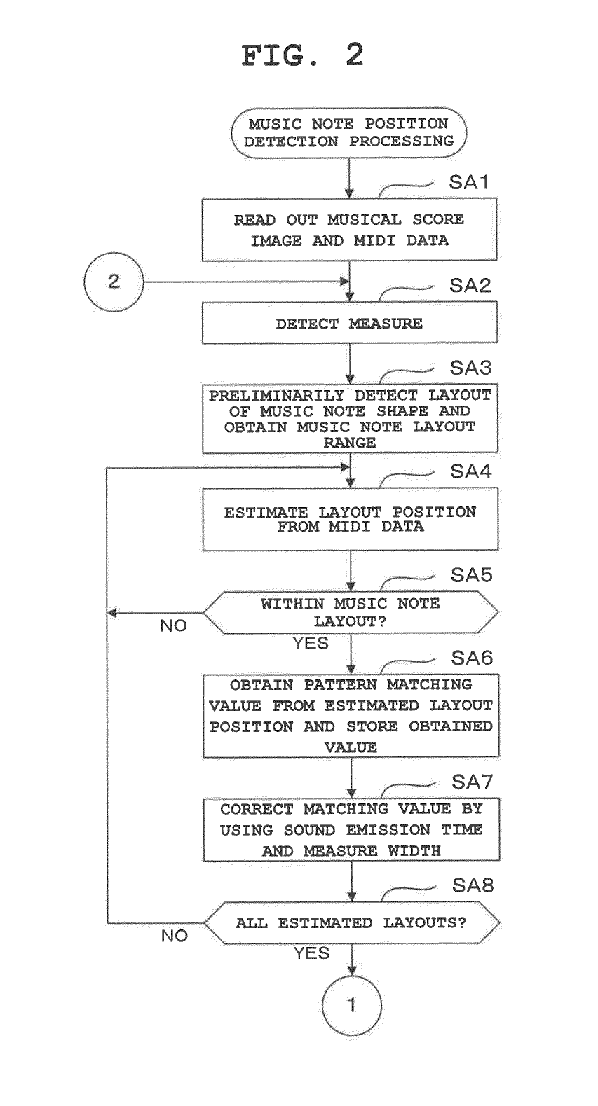

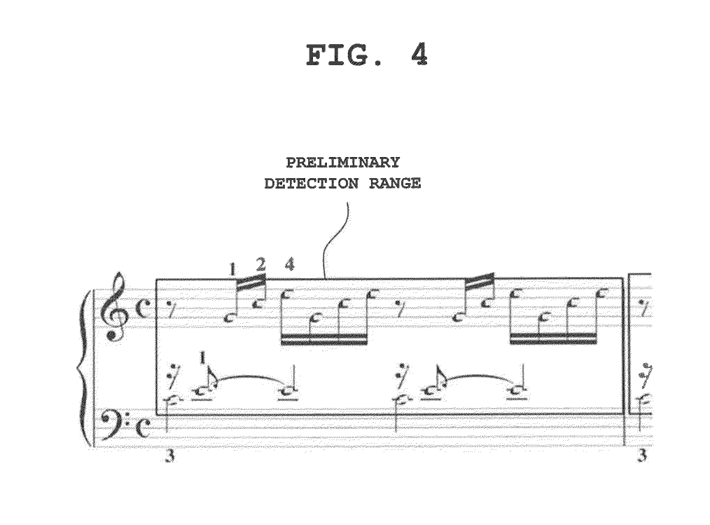

Next, the operation of music note position detection processing by the CPU 10 is described with reference to FIG. 2 to FIG. 6. FIG. 2 is a flowchart of the operation of the music note position detection processing. This processing is performed in response to a mode switch operation on the operation section 13. When this processing is started, the CPU 10 proceeds to Step SA1 depicted in FIG. 2, and reads out musical score. image data and music note data (MIDI data) from the data area of the RAM 12 into the work area.

Subsequently, at Step SA2, the CPU 10 performs the image recognition of the musical score image data to detect a bar line in the musical score and, based on the detection result, divides the musical score image data for each measure. Next, at Step SA3, the CPU 10 performs preliminary inspection of the layout of music notes (a music note shape layout) in the display area of a specific measure obtained based on the detected bar-line information to obtain a music note layout range.

Next, the CPU 10 proceeds to Step SA4, and estimates a position where each music note is to be placed., by using the music note data (MIDI data). Specifically, when the musical score is a piano's grand staff, the musical score has forty-eight position conditions, such as two scales (the C scale and the F scale), two positions of staffs (an upper staff and a lower staff), three signs (flat, sharp, and natural) to lower and raise a note by a semitone, and four music note positions (center, upper or lower, above, and below the staff), and all combinations of these conditions are laid out to estimate the position of each music note.

Then at Step SA5, the CPU 10 judges whether the estimated position of each music note obtained at Step SA4 is within a music note layout range. When the estimated position is outside the music note layout range obtained by the preliminary detection or when the layout determined by a pitch (a note number) in the MIDI data is improper layout that is above, below, or in the middle of the staff, the judgment result is “NO”, and the CPU 10 returns to Step SA4 to exclude the position from position candidates.

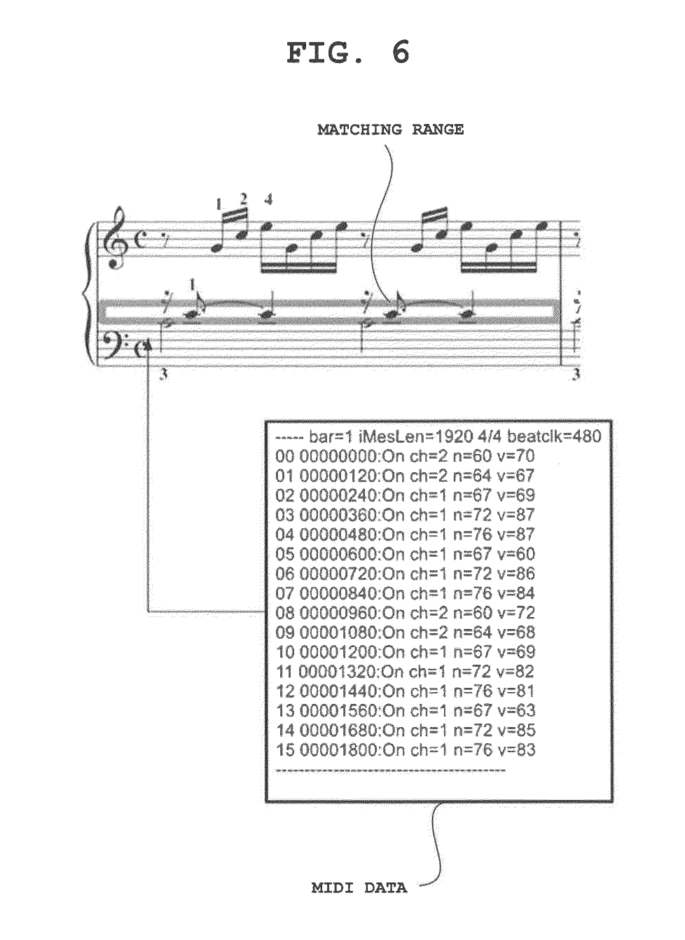

Conversely, when the estimated position of each music note is within the music note layout range, the judgment result at Step SA5 is “YES”, and the CPU 10 proceeds to Step SA6. At Step SA6, the CPU 10 sets a detection range whose height in a vertical direction with respect to the estimated position is equal to the staff height and width in a horizontal direction is equal to the width in the preliminary detection. In addition, the CPU 10 performs pattern matching for music notes in this range with three music note types (a whole note, a half note, and a quarter note), and stores a matching value (a degree of coincidence) and a detected position of each music note. FIG. 6 is a diagram showing an example of pattern matching. As can be seen from this example, since the layout position of each music note is specified with the MIDI data, matching in a narrow range is sufficient, and therefore high detection accuracy can be achieved.

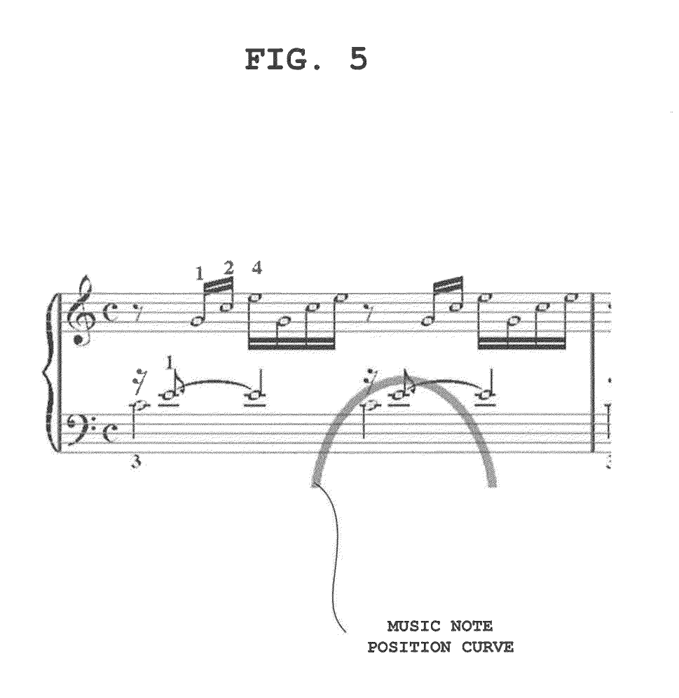

Subsequently at Step SA7, the CPU 10 corrects the matching value by using a sound emission time and a measure width. The music note detected by the pattern matching is at a musical score position more to the left as the sound emission time is earlier and, conversely, at a musical score position more to the right as the sound emission time is later. Therefore, weighting is performed with the layout estimated position of the music note being taken as a maximum value. As a matter of course, since the music note position does not coincide with the sound emission time, a gentle correction curve (a music note position curve) is provided, an example of which is depicted in FIG. 5. When the same music notes continue, the detection values are equal in view of the shape, but are corrected with the sound emission time of the MIDI data to obtain the most likely locations.

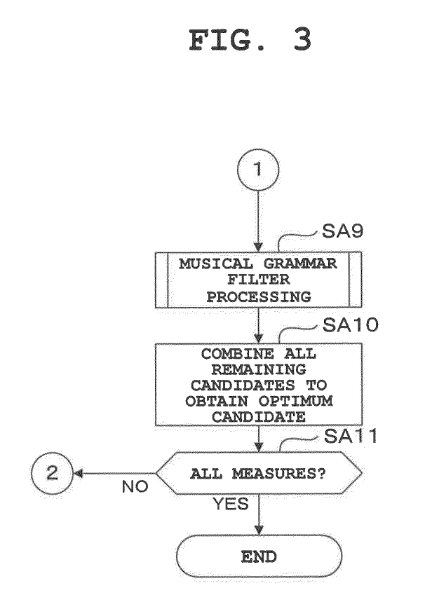

Then at Step SA8, the CPU 10 judges whether all music notes in the measure have been completely detected. When detection has not been completed, the judgment result is “NO”, and the CPU 10 returns to Step SA4. Thereafter, Step SA4 to Step SA8 are repeated until all music notes in the measure are completely detected. Then, after all music notes are completely detected, the judgment result at Step SA8 is “YES”, and therefore the CPU 10 performs Step SA9 depicted in FIG. 3.

At Step SA9, the CPU 10 performs musical grammar filtering on the position candidates obtained so far (the detection position conditions, the matching values, and the detected positions). That is, musical grammar filter processing is performed (which will be described in detail further below) in which musically improper position candidates such as those out of rules (arrangements) in musical score notation and musicology are excluded to narrow down the candidates.

Subsequently at Step SA10, the CPU 10 totalize all combinations of the position candidates obtained by narrowing down by the musical grammar filter processing, and outputs a position candidate with the highest evaluation value as the position of the music note. The outputted position of the music note is stored in the music note position storage area of the RAM 12. Then at Step SA11, the CPU 10 judges whether all measures have been completely processed. When all measures have not been completely processed, the judgment result is “NO”, and therefore the CPU 10 returns to Step SA2 (refer to FIG. 2). Conversely, when all measures have been completely processed, the determination result is “YES”, and therefore the CPU 10 ends the processing.

(2) Operation of Musical Grammar Filter Processing

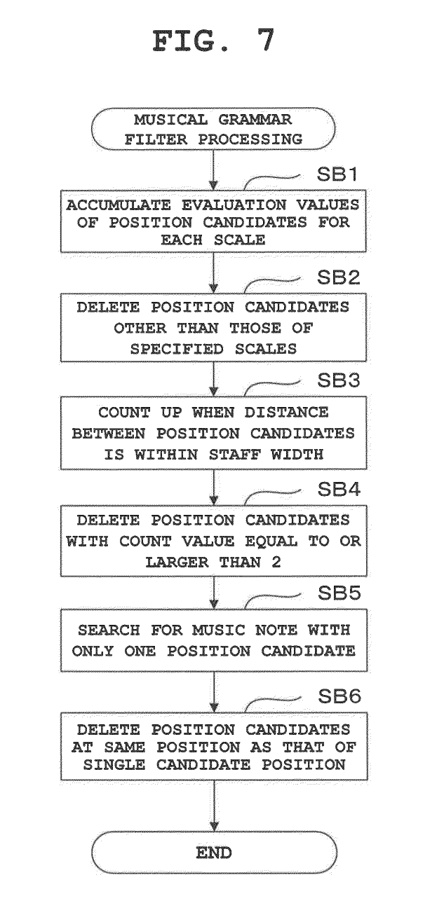

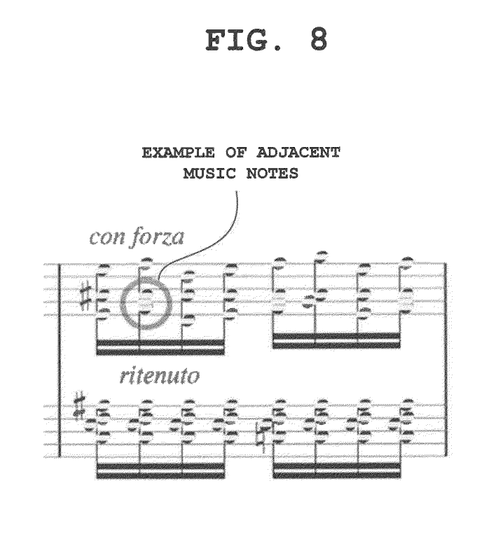

Next, the operation of musical grammar filter processing is described with reference to FIG. 7 and FIG. 8. When this processing is started via Step SA9 (refer to FIG. 3) of the music note position detection processing described above, the CPU 10 proceeds to Step SB1 depicted in FIG. 7, and accumulates evaluation values of the position candidates for each scale. That is, scale combinations are taken for each of the upper and lower staffs and their evaluation values are totalized.

Next at Step SB2, the CPU 10 assumes that those with a high total value are upper-limit and lower-limit scales in the musical score, and deletes position candidates other than those of the above-described scales. This is because a musical grammar without a scale change in a measure is presumed. Subsequently at Step SB3, the CPU 10 counts cases where a distance between position candidates is within the staff width. At Step SB4, the CPU 10 deletes position candidates with a count value equal to or larger than 2. That is, if the count value is equal to or larger than 2, this means that two music notes overlap each other, and therefore they are taken as adjacent music notes that are improper in a musical score and relevant position candidates are deleted. FIG. 8 depicts an example of such adjacent music notes.

Then at Step SB5, the CPU 10 searches for a music note with only one position candidate. Then, at subsequent Step SB6, the CPU 10 deletes position candidates at the same position as this single candidate. That is, when a music note has only a single position, candidates of the other notes having a plurality of position candidates which are at the same position as the single position are deleted. Since all music notes on the musical score are eventually at different positions the CPU 10 prioritizes the music note laid out at a single position.

As such, in the musical grammar filter processing, among the obtained position candidates (the detection position conditions the matching values, and the detected positions), musically improper position candidates such as those out of rules (arrangements) in musical score notation are excluded to narrow down the candidates.

As described above, in the first embodiment, the CPU 10 detects bar lines in a musical score image and divides at each bar line. Subsequently, the CPU 10 obtains a layout range of music notes in each measure obtained by the division. If the estimated position of a music note estimated in the layout range by using music note data (MIDI data) is out of the layout range, that music note is excluded. If the estimated position of the music note is within the layout range, a music note in a detection range corresponding to the estimated position is detected by pattern matching, a matching value and a detected position obtained by the detection are stored as position candidates, and the matching value of the position candidates is corrected with the sound emission time and the measure width. Subsequently, from among the position candidates, musically improper position candidates such as those out of rules (arrangements) in musical score notation are excluded to narrow down the candidates. Then, from among the position candidates obtained by narrowing down, a position candidate with the highest evaluation value is outputted as the position of the music note. Therefore, based on the musical score image and music note data that are of the same musical piece but are independent from and not correlated with each other, the position of a music note in the musical score image corresponding to a sound represented by the music note data can be detected.

### Second Embodiment

Next, a second embodiment is described. In the first embodiment described above, based on a musical score image and music note data that are of the same musical piece but are independent from and not correlated with each other, the position of a music note in the musical score image corresponding to a sound represented by the music note data is detected. In the second embodiment, when thus found position of the music note in the musical score image is specified by a user's touch operation, the sound of the music note at the specified position is emitted.

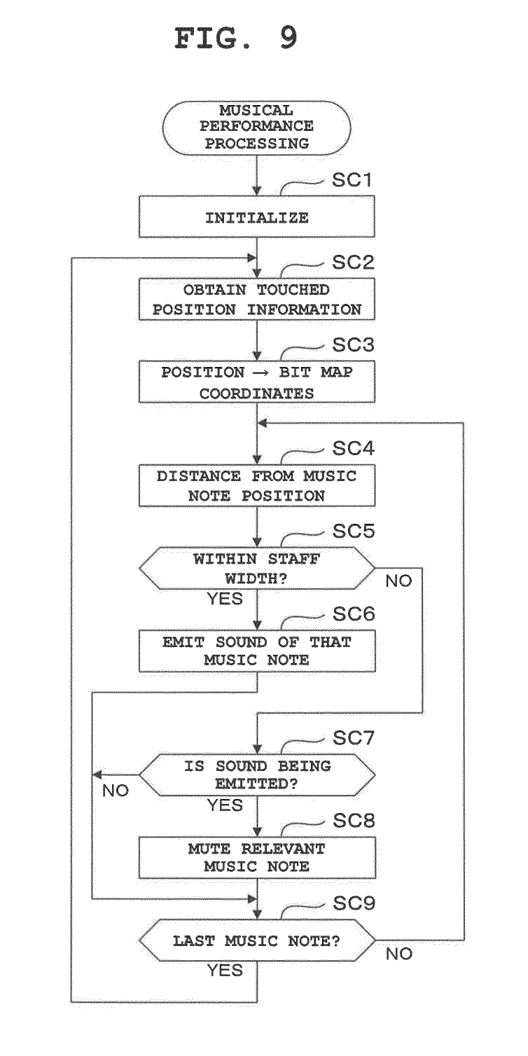

The structure of the second embodiment is the same as that of the first embodiment described above, and therefore is not described herein. In the following descriptions, the operation of musical performance processing according to the second embodiment is described. FIG. 9 is a flowchart of the operation of musical performance processing according to the second embodiment. This processing is performed in response to a mode switch operation on the operation section 13.

When the processing starts the CPU 10 proceeds to Step SC1 depicted in FIG. 8, and initializes each section of the musical instrument. Subsequently at Step SC2, the CPU 10 obtains touched position information. The touched position information herein refers to information generated when the user performs a touch operation on a desired point on a musical score image displayed on the screen of the display section 14, via the touch panel 15.

Next at Step SC3, the CPU 10 performs positional conversion of the touched point obtained at Step SC2 in consideration of a current musical score display magnification to calculate a bit map coordinate value in the musical score image. If the musical score display is to be at unity magnification, the bit map coordinate values represent the same position. In the case of double zoomed-in display, the bit map coordinate values represent a position obtained by adding a display offset and a half of the touched point together. Then, the CPU 10 proceeds to Step SC4, and calculates a distance between the bit map coordinate value obtained at Step SC3 and the position of each music note stored in the music note position storage area of the RAM 12.

Subsequently at Step SC5, the CPU 10 judges whether the calculated distance is within a staff width. If the distance is within the staff width, the judgment result is “YES”, and therefore the CPU 10 proceeds to Step SC6. At Step SC6, the CPU 10 instructs the sound source 16 to perform note-on based on the music note data (MIDI data) associated with the relevant music note, and then proceeds to Step SC9. In the case of a chord in which a plurality of music notes gather at one position in the staff width, the CPU 10 causes the sound source 16 to simultaneously emit a plurality of sounds based on the music note data (MIDI data) associated with each music note configuring the chord.

Conversely, if the distance is not within the staff width, the judgment result at Step SC5 is “NO”, and therefore the CPU 10 proceeds to Step SC7. At Step SC7, the CPU 10 judges whether the sound of the music note is being emitted. If the sound is not being emitted, the judgment result is “NO”, and therefore the CPU 10 proceeds to Step SC9. If the sound of the music note is being emitted, the judgment result is “YES”, and therefore the CPU 10 proceeds to Step SC8. At Step SC8, the CPU 10 instructs the sound source 16 to perform note-off based on the music note data (MIDI data) associated with the relevant music note, and then proceeds to Step SC9.

Subsequently at Step SC9, the CPU 10 judges whether distance calculation for the last music note in the musical piece has been completed. If distance calculation has not been completed, the judgment result is “NO” and the CPU 10 repeats the processing at Step SC4 and the following processing. If distance calculation for the last music note in the musical piece has been completed, the judgment result at Step SC9 is “YES”, and therefore the CPU 10 returns to Step SC2.

As such, in the musical performance processing, when the user performs a touch operation on a musical score image displayed on the screen, the CPU 10 sets a circular detection range whose radius centering on the touched point is equal to the staff width. Then, from among the positions of the respective music notes stored in the music note position storage area of the RAM 12, a music note included in the circular detection range is taken as a music note subjected to the touch operation, and the sound of the music note is emitted. When the user releases the touch, the music note whose sound is being emitted becomes out of the circular detection range and is muted.

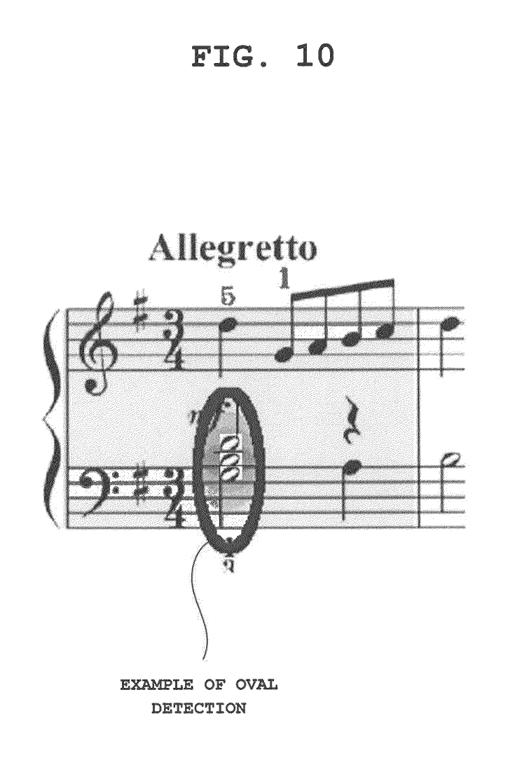

As described above, in the second embodiment, the CPU 10 sets a circular detection range whose radius centering on the touched point is equal to the staff width. However, the present invention is not limited thereto. For example, as in an example depicted in FIG. 10, the CPU 10 may set an oval detection range. Since a chord is placed in the height direction of a musical score and the horizontal direction represents time, if the CPU 10 sets a vertically-elongated oval detection range, this can make it easy to put a chord and make it difficult to put unwanted simultaneous sounds.

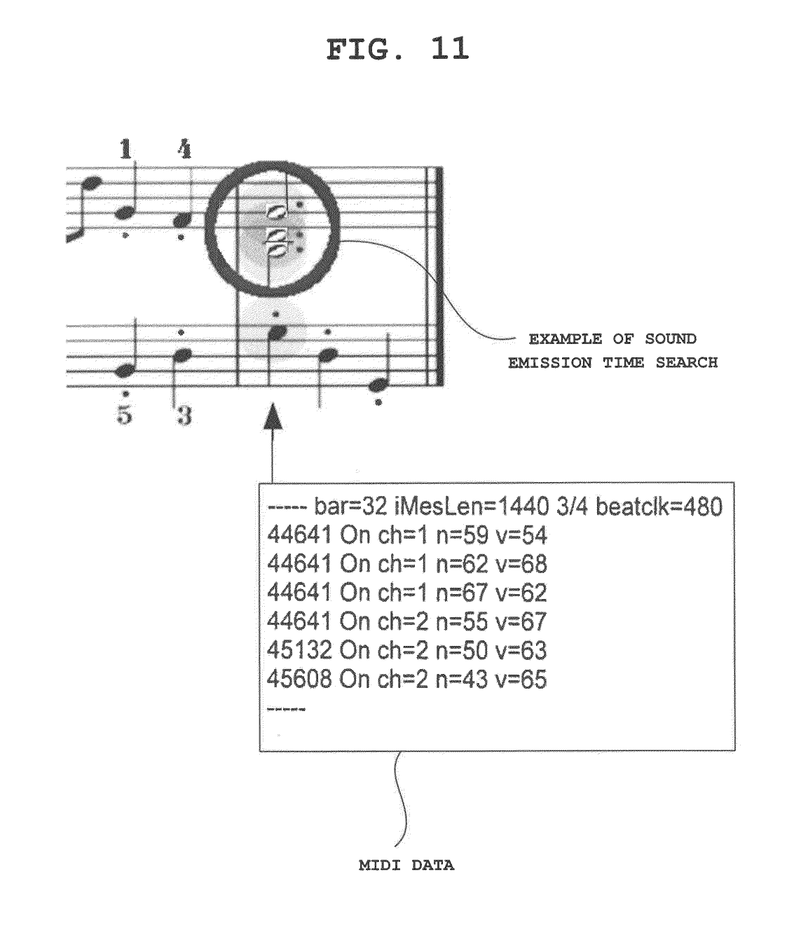

Also, in the second embodiment, the CPU 10 detects a music note subjected to a touch operation by using only the distance from the touched point. However, the present invention is not limited thereto, and a configuration may be adopted in which a music note subjected to a touch operation is detected further considering the sound emission time (note-on timing) of the music note. FIG. 11 is a diagram of such an example. As depicted in FIG. 11, with reference to a sound emission time in MIDI data corresponding to a music note nearest to a touched point, the sound of a music note near in time from the sound emission time is simultaneously emitted. This can facilitate musical performance.

### Modification Example

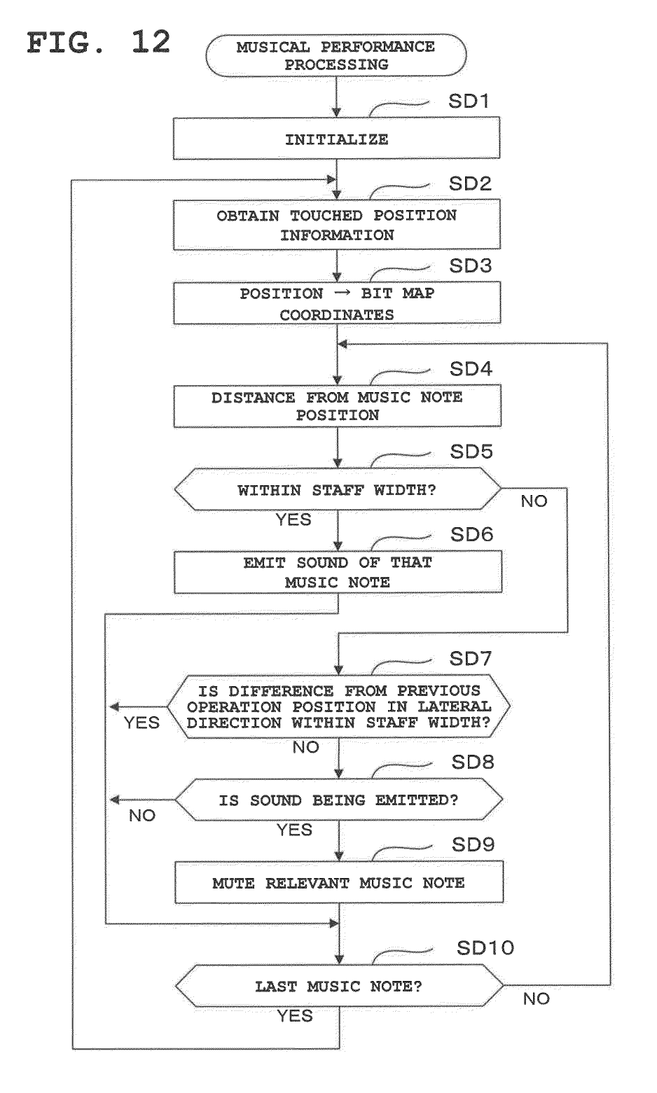

Heat, a modification example of the second embodiment is described with reference to FIG. 12 to FIG. 15. In the above-described second embodiment, a music note a sound of which is to be emitted is specified by a touch operation on a musical score image. However, in this modification example, a music note a sound of which is to be emitted is specified by a slide operation on a musical score image. The slide operation herein refers to an operation to sequentially move a touched point.

When musical performance processing according to the modification example starts, the CPU 10 proceeds to Step SD1 depicted in FIG. 12, and initializes each section of the musical instrument. Subsequently at Step SD2, the CPU 10 obtains touched position information. The touched position information herein refers to information generated when the user performs a touch operation on a desired point on a musical score image displayed on the screen of the display section 14, via the touch panel 15.

Next at Step SD3, the CPU 10 performs positional conversion of the touched point obtained at Step SD2 in consideration of a current musical score display magnification to calculate a bit map coordinate value in the musical score image. If the musical score display is to be at unity magnification, the bit map coordinate values represent the same position. In the case of double zoomed-in display, the bit map coordinate values represent a position obtained by adding a display offset and a half of the touched point together. Then, the CPU 10 proceeds to Step SD4, and calculates a distance between the bit map coordinate value obtained at Step SD3 and the position of each music note stored in the music note position storage area of the RAM 12.

Subsequently at Step SD5, the CPU 10 judges whether the calculated distance is within the staff width. If the distance is within the staff width, the judgment result is “YES”, and therefore the CPU 10 proceeds to Step SD6. At Step SD6, the CPU 10 instructs the sound source 16 to perform note-on based on the music note data (MIDI data) associated with the relevant music note and then proceeds to Step SD10. In the case of a chord in which a plurality of music notes gather at one position in the staff width, the CPU 10 causes the sound source 16 to simultaneously emit a plurality of sounds based on the music note data (MIDI data) associated with each music note configuring the chord.

Conversely, if the distance is not within the staff width, the judgment result at Step SD5 is “NO”, and therefore the CPU 10 proceeds to Step SD7. At Step SD7, the CPU 10 judges whether a slide operation whose difference from the previous touched point in a horizontal direction is within the staff width has been performed. If a slide operation whose difference from the previous touched point in the horizontal direction is within the staff width has been performed, or in other words, if a slide operation in a height direction has been performed, the judgment result is “YES”, and therefore the CPU 10 proceeds to Step SD10 described further below. Therefore, if the user performs a slide operation in the height direction with the sound of the music note within the staff width being emitted by the previous touch operation, the sound is continuously emitted without being muted.

At Step SD7, if a slide operation whose movement amount exceeds the staff width has been performed from the previous touched point in the horizontal direction, the judgment result at Step SD7 is “NO”, and therefore the CPU 10 proceeds to Step SD8. At Step SD8, the CPU 10 judges whether the sound of the music note is being emitted. If the sound is not being emitted, the judgment result is “NO”, and therefore the CPU 10 proceeds to Step SD10. Conversely, if the sound of the music note is being emitted, the judgment result is “YES”, and therefore the CPU 10 proceeds to Step SD9. At Step SD9, the CPU 10 instructs the sound source 16 to perform note-off based on the music note data (MIDI data) associated with the relevant music note and then proceeds to Step SD10.

Subsequently at Step SD10, the CPU 10 judges whether distance calculation for the last music note in the musical piece has been completed. If distance calculation has not been completed, the judgment result is “NO”, and therefore the CPU 10 repeats the processing at Step SD4 and the following processing. If distance calculation for the last music note in the musical piece has been completed, the judgment result at Step SD10 is “YES”, and therefore the CPU 10 returns to Step SD2.

As such, in the musical. performance processing according to the modification example, when the user performs a touch operation on a musical score image displayed on the screen, the CPU 10 sets a circular detection range whose radius centering on the touched point is equal to the staff width. Then, from among the positions of respective music notes stored in the music note position storage area of the RAM 12, a music note included in the circular detection range is taken as a music note subjected to the touch operation, and the sound of the music note is emitted. When the user releases the touch operation, the music note whose sound is being emitted becomes out of the circular detection range and is muted. Also, if the user performs a slide operation in the height direction with the sound of the music note within the staff width being emitted by the previous touch operation, the sound is continuously emitted without being muted.

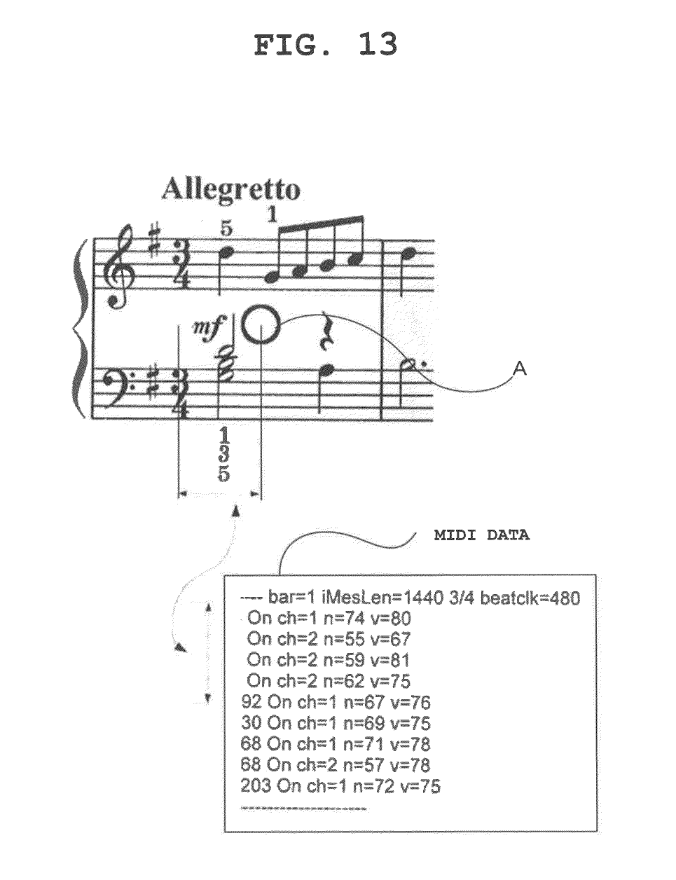

In this modification example, a sound is continuously emitted by a slide operation in the height direction. However, automatic musical performance may be performed by a touch operation. Although the position of a music note on a musical score does not strictly coincide with the sound emission time of the music note data, this correspondence can be used as a rough guideline. Accordingly, a ratio between a measure width and the position of a touch operation is converted to a musical performance time length in the measure, and the music note data of music notes included in the musical performance time length obtained by the conversion are subjected to automatic musical performance. For example, when a touch operation is performed on point A in the first measure of the example of a musical score depicted in FIG. 13, a ratio between the first measure and point A subjected to the touch operation is converted to a musical performance time length, and automatic musical performance for the MIDI data of music notes included in the musical performance time length obtained by the conversion is performed.

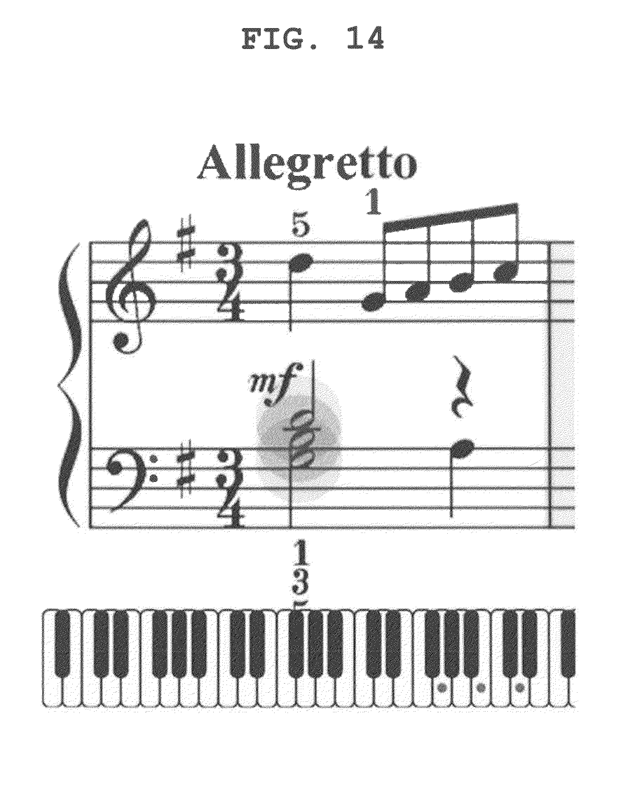

Also, in the first and second embodiments and the modification example, a music note in a musical score image displayed on a screen is specified by a touch panel operation. However, the present invention is not limited thereto, and a configuration may be adopted in which a keyboard image is displayed below a musical score, and the position of a key corresponding to a currently specified music note is displayed as a guide, as in an example depicted in FIG. 14. This is suitable for practicing piano play.

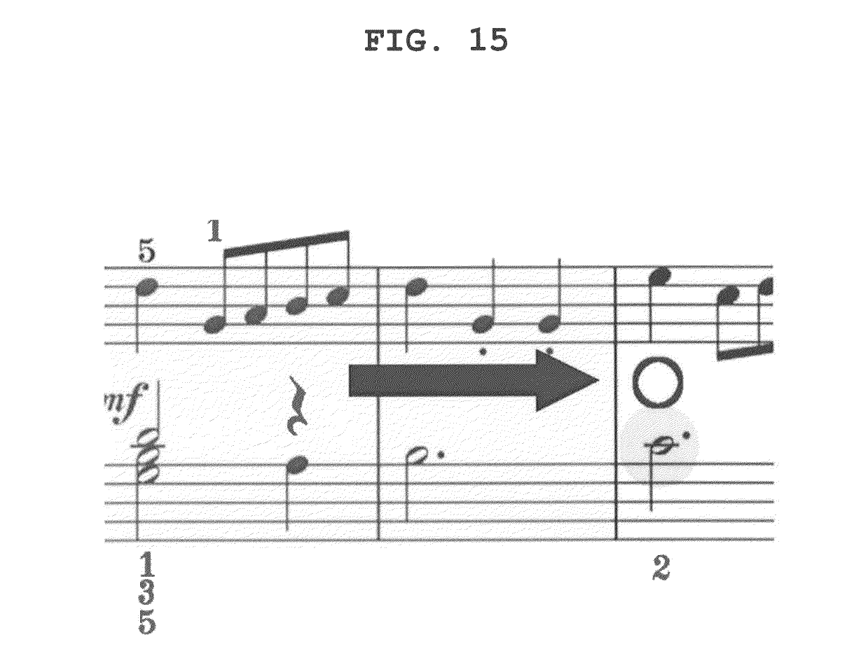

Moreover, in the modification example, if the CPU 10 detects that the user has performed a slide operation over a bar line as in an example depicted in FIG. 15, the CPU 10 assumes that a repeat of the measure range indicated by the arrow has been specified, and performs automatic musical performance for the music notes of the measures. This enables a seamless operation to emit a sound of a music note by touching the music note, emit the sound of a melody line by tracing music notes, and perform automatic musical performance by releasing the touch.

While the present invention has been described with reference to the preferred embodiments, it is intended that the invention be not limited by any of the details of the description therein but includes all the embodiments which fall within the scope of the appended claims

What is claimed is:

1. A music note position detection apparatus comprising:
an obtaining section which detects bar lines in musical score image data to divide at each bar line, and obtains a layout range of music notes in each measure obtained by division;
an extracting section which estimates a position of each music note in the layout range obtained by the obtaining section by using a plurality of music note data constituting a musical piece, and extracts a matching value between the music note at the estimated position and a position of the music note detected on the musical score image data, and the detected position of the music note, as position candidates; and
a determining section which excludes a musically improper position candidate from among the position candidates extracted by the extracting section, and determines a detected position of a remaining position candidate as a position of the music note.

2. The music note position detection apparatus according to claim 1, wherein the determining section further determines a detected position of a position candidate with a highest degree of coincidence among remaining position candidates as the position of the music note.

3. The music note position detection apparatus according to claim 1, wherein the extracting section comprises an estimated position excluding section which excludes the position estimated by using the music note data when the position is out of the layout range obtained by the obtaining section.

4. The music note position detection apparatus according to claim 1, further comprising:
a correcting section which corrects the matching value of the position candidates extracted by the extracting section by using a sound emission time and a measure width.

5. The music note position detection apparatus according to claim 1, wherein the determining section accumulates evaluation values of the position candidates extracted by the extracting section for each scale, takes a scale with a high accumulation value as a correct scale, and deletes position candidates of other scales.

6. The music note position detection apparatus according to claim 1, wherein the determining section counts cases where a distance between position candidates is within a staff width from among the position candidates extracted by the extracting section, and deletes a position candidate with a count value equal to or larger than 2.

7. The music note position detection apparatus according to claim 1, wherein the determining section prioritizes a music note having a single position candidate, and deletes a position candidate at same position as the single position candidate.

8. An electronic musical instrument comprising:
the music note position detection apparatus according to claim 1;
a control section which captures an operation signal externally supplied, and generates an event;
a sound source which generates a musical sound in response to the generated event.

9. A non-transitory computer-readable storage medium having stored thereon a program that is executable by a computer, the program being executable by the computer to perform functions comprising:
obtainment processing for detecting bar lines in musical score image data to divide at each bar line and obtaining a layout range of music notes in each measure obtained by division;
extraction processing for estimating a position of each music note in the layout range obtained in the obtainment processing by using a plurality of music note data constituting a musical piece, and extracting a matching value between the music note at the estimated position and a position of the music note detected on the musical score image data, and the detected position of the music note, as position candidates;
determination processing for excluding a musically improper position candidate from among the position candidates extracted in the extraction processing, and determining a detected position of a remaining position candidate as a position of the music note.

10. The non-transitory computer-readable storage medium according to claim 9, wherein the determination processing further determines a detected position of a position candidate with a highest degree of coincidence among remaining position candidates as the position of the music note.

11. The non-transitory computer-readable storage medium according to claim 9, wherein the extraction processing excludes, when the position estimated by using the music note data is out of the layout range obtained in the obtainment processing, the estimated position.

12. The non-transitory computer-readable storage medium according to claim 9, wherein the functions further comprise correction processing for correcting the matching value of the position candidates extracted in the extraction processing by using a sound emission time and a measure width.

13. The non-transitory computer-readable storage medium according to claim 9, wherein the determination processing accumulates evaluation values of the position candidates extracted in the extraction processing for each scale, takes a scale with a high accumulation value as a correct scale, and deletes position candidates of other scales.

14. The non-transitory computer-readable storage medium according to claim 9, wherein the determination processing counts cases where a distance between position candidates is within a staff width from among the position candidates extracted in the extraction processing, and deletes a position candidate with a count value equal to or larger than 2.

15. The non-transitory computer-readable storage medium according to claim 9, wherein the determination processing prioritizes a music note having a single position candidate, and deletes a position candidate at same position as the single position candidate.

16. A music note position detection method comprising:
detecting bar lines in musical score image data to divide at each bar line, and obtaining a layout range of music notes in each measure obtained by division;
estimating a position of each music note in the obtained layout range by using a plurality of music note data constituting a musical piece, and extracting a matching value between the music note at the estimated position and a position of the music note detected on the musical score image data, and the detected position of the music note, as position candidates; and
excluding a musically improper position candidate from among the extracted position candidates, and determining a detected position of a remaining position candidate as a position of the music note.

17. The music note position detection method according to claim 16, wherein a detected position of a position candidate with a highest degree of coincidence among remaining position candidates is further determined as the position of the music note.

18. The music note position detection method according to claim 16, wherein the position estimated by using the music note data is excluded when the estimated position is out of the obtained layout range.

19. The music note position detection method according to claim 16, wherein the matching value of the extracted position candidates is further corrected by using a sound emission time and a measure width.

20. The music note position detection method according to claim 16, wherein evaluation values of the extracted position candidates are accumulated for each scale, a scale with a high accumulation value is taken as a correct scale, and position candidates of other scales are deleted.

21. The music note position detection method according to claim 16, wherein cases where a distance between position candidates is within a staff width are counted from among the extracted position candidates, and a position candidate with a count value equal to or larger than 2 is deleted.

22. The music note position detection method according to claim 16, wherein a music note having a single position candidate is prioritized, and a position candidate at same position as the single position candidate is deleted.
